(19) United States
(12) Patent Application Publication
(10) Pub. No.: US 2014/0301303 A1
(43) Pub. Date: Oct. 9, 2014

(54) Interference Mitigation

(71) Applicant: Broadcom Corporation, Irvine, CA (US)

(72) Inventors: Timo Eric ROMAN, Espoo (FI); Tommi Tapani KOIVISTO, Espoo (FI); Mihai Horatiu ENESCU, Espoo (FI); Tero Heikki Petteri KUOSMANEN, Tampere (FI)

(73) Assignee: Broadcom Corporation, Irvine, CA (US)

(21) Appl. No.: 14/245,129

(22) Filed: Apr. 4, 2014

(30) Foreign Application Priority Data
Apr. 5, 2013 (GB) 1306183.3

(51) Int. Cl. H04L 5/00

(52) U.S. Cl. CPC H04L 5/0073; H04L 5/0035
USPC 370/329

(57) ABSTRACT

Measures including a method, comprising deriving at least one of one or more statistics of an interfering channel and a rate matching parameter of the interfering channel based on an interfering colocation information received from a serving transmission point device, wherein the interfering channel comprises a channel between an apparatus performing the method and an interfering transmission point device different from the serving transmission point device.

### TECHNICAL FIELD

The present invention relates to apparatus, methods, and computer program products for a receiver and a corresponding transmitter. More particularly, but not exclusively, the present invention relates to apparatus, methods, and computer program products for a receiver to mitigate interference and a corresponding transmitter.

### BACKGROUND

Abbreviations:

3GPP 3^{rd} Generation Partnership Project

CoMP Coordinated Multi-Point Transmission

CQI Channel Quality Indicator

CRS Cell-Specific Reference Signal

CSI Channel State Information

CSI-RS CSI-Reference Signal

DCCH Downlink Control Channel

DCI Downlink Control Information

DL Downlink

eNB Enhanced Node B (Node B in LTE)

EPDCCH Evolved PDCCH

GSM Global System for Mobile Communication

IC Interference Cancellation

LAN Local Area Network

LTE™ Long Term Evolution

LTE-A™ Long Term Evolution Advanced

MBSFN Multicast-Broadcast Single Frequency Network

MIMO Multiple Input Multiple Output

NZP Non-Zero Power

PDCCH Physical DCCH

PDSCH Physical Downlink Shared Channel

PMI Precoding Matrix Indicator

PQI PDSCH Rate matching and Quasi-colocation Indicator

PRB Physical Resource Block

QCL Quasi Colocated

RAN Radio Access Network

RE Resource Element

RI Rank Indicator

RLM Radio Link Monitoring

RRC Radio Resource Control

RRM Radio Resource Management

RSRP RS Received Power

RSRQ RS Received Quality

SIC Successive Interference Cancellation

TM Transmission Mode

UE User Equipment

UL Uplink

WLAN Wireless LAN

WiFi Wireless Fidelity

ZP Zero Power

In PDSCH (and EPDCCH) reception, the UE receiver requires parameters for rate matching prior to demodulation. Also, long-term statistics about the radio channel are needed in channel state information (CSI) estimation and demodulation, for example for selecting the channel estimation filters and for correcting any residual timing and frequency errors before demodulation. The channel statistics can be estimated from reference signals. However, in LTE it is by default not known to the UE which reference signals are transmitted from quasi-colocated antenna ports. Quasi-colocation may be defined as e.g. in 3GPP TS 36.211, section 6.2.1, according to which two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, and average delay. According to 3GPP TS 36.211, a UE shall not assume that two antenna ports are quasi co-located unless specified otherwise.

In particular, the UE not knowing which reference signals are transmitted from quasi-colocated antenna ports becomes an issue in LTE coordinated multi-point transmission (CoMP) and in case of advanced receivers as in both cases the UE is dealing with signals coming from physically non-colocated transmission points and hence, the radio channel statistics may be substantially different between different reference signals (antenna ports), e.g. due to different propagation delays and frequency offsets between the radio links associated to each different transmission point. Similarly, the rate matching parameters may vary dynamically depending on the transmitting point, as for instance MBSFN subframe configurations or cell-specific reference signal parameters (number of antenna ports, frequency shift) may be different.

For the purposes of CoMP, Release 11 LTE defines PDSCH (and EPDCCH) rate matching and quasi-colocation assumptions which essentially state which overhead signals the UE should assume in PDSCH rate matching and which reference signals or antenna ports the UE may assume quasi-colocated (meaning that the long-term channel statistics are the same between these antenna ports).

LTE defines several types of reference signals:
Cell-specific reference signals (CRS), which are common to all UEs, broadcasted all the time within the cell and used for detection of cell-specific transmissions, for instance all common channels, as well as for CSI feedback in transmission modes 1-8. CRS are also used for UE measurements such as e.g. radio resource management (RRM) measurements (RSRP/RSRQ) as well as for radio link monitoring (RLM). A transmission mode defines the maximum transmission rank and whether the transmission uses closed-/open-loop spatial multiplexing. The number of CRS ports in a given cell is provided as implicit information to the UE when it reads the master information block (MIB) over the physical broadcast channel (P-BCH).
Channel state information reference signals (CSI-RS), which are used by the UEs to estimate channel state information for CSI feedback (PMI/CQI/RI) purposes in transmission modes 9, 10 and likely new transmission modes to be standardized in Rel-12 timeframe and beyond. The CSI-RS are periodic and transmitted separately from each transmission point, i.e. even if transmission points belong to the same cell there can be distinct CSI-RS transmitted. CSI-RS are not used for PDSCH demodulation.
UE-specific reference signals or demodulation reference signals (DM-RS), which are used by the UE for demodulation. The DM-RS are only transmitted on scheduled physical resource blocks. DM-RS may be spatially precoded and undergo the same spatial precoding as the associated PDSCH.

Up to LTE Rel-10, UE typically estimates the long-term channel statistics required for CSI-RS or DM-RS channel estimation from CRS. Then, corresponding channel estimates over CSI-RS are used for CSI (CQI/PMI/RI) feedback to the eNB, and channel estimates over DM-RS serve the purpose of UE data demodulation. The following channel statistics are typically estimated from reference signals (RS):
Delay spread of the channel (or equivalently frequency correlation properties);
Doppler spread of the channel (or equivalently time correlation properties);
Time and frequency offset (for fine time and frequency synchronization and tracking);
Signal-to-interference-and-noise ratio (SINR) or more generally interference covariance matrix for CSI feedback as well as demodulation.

In the context of this document, each of these statistics may also be referred to as long-term (channel) statistics. Additionally, reference symbols such as e.g. CRS or CSI-RS may serve as support for estimating the average received reference signal power (RSRP) associated to a given transmission point.

The above statistics allow the UE to parameterize its channel estimator such that the derived channel estimation filter coefficients match as close as possible the power-delay and Doppler profiles of the channel impulse response to be estimated for demodulation or CSI feedback purposes. The operation point in terms of SINR needs also to be set properly for optimum filtering performance in terms of mean square error (MSE). Another aspect relates to above mentioned time and frequency tracking typically performed over reference signals: the estimated fine time and frequency synchronization parameters are typically taken into account when deriving CSI feedback or when performing demodulation.

In Release 11, with CoMP it is no longer possible to make similar assumptions about having the same long-term channel statistics between different reference signals since the RS might be transmitted from physically non-colocated transmission points and would have different long-term channel statistics. In particular, CRS can be broadcasted simultaneously from all transmission points within the cell and hence do not provide a suitable reference for estimating channel statistics corresponding to a single transmission point for either demodulation or for CSI feedback. As a solution, in Release lithe UE is signaled in DCI which CSI-RS resource can be assumed quasi-colocated with the DM-RS associated with the scheduled transmission. Hence, the UE can utilize either CSI-RS or only DM-RS for timing and power delay profile determination. Additionally, CSI-RS may be transmitted from an antenna quasi-colocated with that transmitting CRS, hence CRS can be used for frequency offset and Doppler spread estimation. With this information the UE is able to select its channel estimation filters for detecting its own PDSCH transmissions.

### BRIEF DESCRIPTION OF THE DRAWINGS

FIG. 1 shows an ASN.1 code of a PQI state table according to 3GPP TS 36.311;

FIG. 2 shows a PQI signaling according to an embodiment of the invention;

FIG. 3 shows a PQI signaling according to an embodiment of the invention;

FIG. 4 shows a PQI signaling according to an embodiment of the invention;

FIG. 5 shows an apparatus according to an embodiment of the invention;

FIG. 6 shows a method according to an embodiment of the invention;

FIG. 7 shows an apparatus according to an embodiment of the invention; and

FIG. 8 shows a method according to an embodiment of the invention.

### DETAILED DESCRIPTION

It is an object of the present invention to improve the prior art. In particular, it is an object to improve interference mitigation.

For rate matching purposes, the UE needs to be aware of the exact PDSCH resource mapping. In addition to knowing the allocated physical resource blocks (PRBs), the UE has to be aware of the presence of any other (overhead) signals within the allocated PRBs. Such overhead signals may be for instance CRS or zero-power CSI-RS. Additionally, the PDSCH starting symbol may vary. All these parameters are also dependent on the transmission point. In Release 11 CoMP, similarly to the quasi-colocation assumptions, the PDSCH rate matching parameters are signaled dynamically to the UE in the DCI that is used for scheduling. Quasi-colocation parameters and PDSCH rate matching parameters are signaled jointly.

For Release 12, advanced receivers are considered as a further means to mitigate or cancel inter-cell interference. In particular, one type of advanced receiver that is being considered is successive interference cancellation (SIC), in which the UE detects the interfering signal and cancels it out before detecting its own signal, thereby reducing interference significantly.

Signaling a CSI-RS to be used as a reference for deriving channel statistics was proposed in GB 1204734.6 and is included in the 3GPP specifications TS 36.211 (section 6.2.1) and TS 36.213 (sections 7.1.10 and 9.1.4.2). This prior art mentions signaling of multiple CSI-RS resources.

PQI states indicate the CSI-RS resources to be used as a reference for deriving channel statistics, as well as the rate matching parameters used for detecting the desired signal. For PDSCH, PQI signaling is described in TS 36.331 section 6.3.2 (PDSCH-Config), TS 36.212 section 5.3.3.1.5D and TS 36.213 sections 7.1.9 and 7.1.10. Conventionally, PQI signaling has been considered only for the case in which the transmission point transmitting the UE's own (desired) PDSCH signal can vary on a subframe basis.

In Release 11, PQI (PDSCH rate matching and quasi-colocation indicator) has been included in DCI format 2D that is used to grant downlink resources to the UE over a downlink control channel (PDCCH or EPDCCH). The PQI indicates the rate matching parameters and also which CSI-RS resource may be assumed quasi-colocated with the DM-RS used for demodulating the allocated PDSCH. In other words, the UE may utilize long-term channel statistics estimated from the CSI-RS for selecting the channel estimation filter for DM-RS channel estimation as well as for compensating for the time and frequency offsets before demodulation. The PQI field according to Release 11 is 2 bits and indicates one out of four PQI states configured by higher layers than medium access control (e.g. RRC). Each PQI state indicates the following information:

1. Number of CRS ports

2. CRS frequency shift

3. MBSFN subframe configuration

4. PDSCH starting symbol

5. Zero-power CSI-RS configuration

6. Quasi-colocated CSI-RS configuration

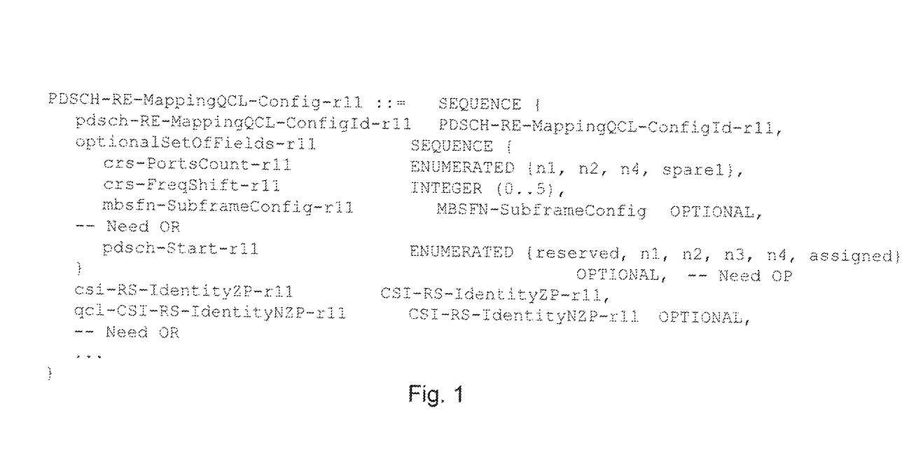

The five first parameters are used for PDSCH rate matching, whereas the quasi-colocated CSI-RS configuration is used only for quasi-colocation purposes. An extract from 3GPP TS 36.331 showing the corresponding ASN.1 code is shown in FIG. 1. The Quasi-colocated CSI-RS configuration is the information element qcl-CSI-RS-IdentityNZP-r11, which is optional and indicates the appropriate CSI-RS.

According to a first aspect of the invention, there is provided apparatus for use in interference mitigation, the apparatus comprising a processing system configured to cause the apparatus to at least derive at least one of one or more statistics of an interfering channel and a rate matching parameter of the interfering channel based on an interfering colocation information received from a serving transmission point device,

wherein the interfering channel comprises a channel between the apparatus and an interfering transmission point device different from the serving transmission point device.

According to embodiments, there is provided apparatus, comprising deriving means adapted to derive at least one of a statistics of an interfering channel and a rate matching parameter of the interfering channel based on an interfering colocation information received from a serving transmission point device, wherein the interfering channel is a channel between the apparatus and an interfering transmission point device different from the serving transmission point device.

According to a second aspect of the invention, there is provided apparatus for use in interference mitigation, the apparatus comprising a processing system configured to cause the apparatus to at least provide an interference colocation information to a user device,

wherein the interference colocation information is intended to be used for deriving at least one of one or more statistics of an interfering channel and a rate matching parameter of the interfering channel, and

wherein the interfering channel comprises a channel between the user device and an interfering transmission point device different from the apparatus.

According to embodiments, there is provided an apparatus, comprising providing means adapted to provide an interference colocation information to a user device, wherein the interference colocation information is intended to be used for deriving at least one of a statistics of an interfering channel and a rate matching parameter of the interfering channel, wherein the interfering channel is a channel between the user device and an interfering transmission point device different from the apparatus.

According to a third aspect of the invention, there is provided a method for use in interference mitigation, the method comprising deriving at least one of one or more statistics of an interfering channel and a rate matching parameter of the interfering channel based on an interfering colocation information received from a serving transmission point device,

wherein the interfering channel comprises a channel between an apparatus performing the method and an interfering transmission point device different from the serving transmission point device.

According to a fourth aspect of the invention, there is provided a method for use in interference mitigation, the method comprising providing an interference colocation information to a user device,

wherein the interference colocation information is intended to be used for deriving at least one of one or more statistics of an interfering channel and a rate matching parameter of the interfering channel, and

wherein the interfering channel comprises a channel between the user device and an interfering transmission point device different from an apparatus performing the method.

Each of the methods of the third and fourth aspects may be a method of interference mitigation.

According to a fifth aspect of the invention, there is provided a computer program product comprising a set of instructions which, when executed on a computerized device, is configured to cause the computerized device to carry out a method according to the third or fourth aspects. The computer program product may be embodied as a computer-readable medium.

According to some embodiments of the invention, for example at least the following advantages are achieved:
Interference mitigation is improved;
Advanced receivers may be used as such also in multi transmission point including e.g. multi-eNB environment; and
Joint detection receivers improve their interference cancellation properties.

Further features and advantages of the invention will become apparent from the following description of preferred embodiments of the invention, given by way of example only, which is made with reference to the accompanying drawings.

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

In the case of advanced receivers, similar problems arise as in the case of CoMP. Therefore, some embodiments of the invention address issues with UE assumptions on PDSCH rate matching and antenna port quasi-colocation/non-colocation in case of advanced UE receivers. PDSCH is an example of a physical downlink channel for transporting user data. For example, with advanced receivers, for detection of the interfering signal, the UE may need the long-term channel statistics in order to select the channel estimation filter for estimating the interferer channel and in order to correct the residual time and frequency offsets. The UE also typically may need the corresponding rate matching parameters which may be different compared to the serving transmission point.

According to some embodiments of the invention, PQI parameters corresponding to interfering transmission points are signaled to the UE in order to enable interference mitigation/cancellation. In embodiments, multiple PQI states are signaled, at least one of which is associated with a UE's (own) signal, and at least one of which is associated with an interfering signal, that the UE may use to cancel or mitigate interference using e.g. an advanced receiver. In some embodiments of the invention, the PQI states indicate the CSI-RS resources to be used as a reference for deriving at least one of channel statistics and (one or more) rate matching parameters used for detecting the corresponding signals (desired or interfering). Depending on whether the PQI state is used for deriving channel statistics only, deriving rate matching parameters only, or deriving both, the PQI state may comprise Quasi-colocated CSI-RS configuration only, at least one of the parameters Number of CRS ports, CRS frequency shift, MBSFN subframe configuration, PDSCH starting symbol, Zero-power CSI-RS configuration, or Quasi-colocated CSI-RS configuration and at least one of the parameters Number of CRS ports, CRS frequency shift, MBSFN subframe configuration, PDSCH starting symbol, Zero-power CSI-RS configuration, respectively.

In some embodiments, the reference for deriving at least one of channel statistics and (one or more) rate matching parameters used for detecting the corresponding signals (desired or interfering) may consist of at least one of a channel state information reference symbol, a channel state information reference symbol resource, a reference symbol, or in general any signal that one may take advantage of in determining said at least one of channel statistics and (one or more) rate matching parameters.

GB 1204734.6 does not mention the utilization of this signaling for the purpose of mitigating/cancelling interference. Even the idea that one of the CSI-RS resources could correspond to interfering transmission(s) is not mentioned in the prior art.

It is noted that some embodiments of the invention may be applied not only to the class of SIC receivers. In one example, the mobile terminal based IC receivers may detect only, and in some examples detect and decode, the interfering codeword(s) in addition to the wanted codeword(s). For instance, joint detection (e.g. maximum likelihood) receivers without a SIC stage as well as other receiver structures (e.g. iterative turbo SIC processing) may also benefit from signaled information on quasi-colocation and rate matching parameters for the interfering codeword(s) in addition to the one signaled for the wanted codeword(s).

Some example implementations of embodiments of the inventions are outlined hereinafter:

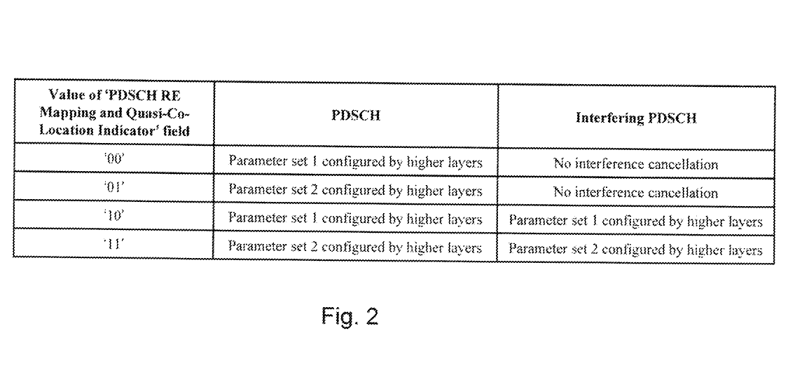

In case of advanced receivers capable of interference mitigation/cancellation, preferably, multiple PQI states are signaled to the UE. One example way is to utilize the same 2-bit PQI field, and link each state with two or more PQI configurations as shown below in FIG. 2. One of the PQI configurations is associated with a UE's own PDSCH transmission (desired signal), whereas the other PQI configurations is associated with the interfering signal(s) that is (/are) to be processed for interference mitigation/cancellation. Each parameter set of the table in FIG. 2 corresponds e.g. to the parameters outlined in FIG. 1, or a subset thereof. If the first bit of the PQI indicator field is 0, no interference cancellation is to be performed based on the PQI state. In the example in FIG. 2, two states are used for normal operation without interference cancellation, and two states are used for indicating parameters for both own PDSCH and interfering PDSCH.

To increase flexibility, the number of PQI bits in the single PQI field may be increased; this would allow a larger number of PQI states and hence PQI combinations to be signaled to the UE.

In some embodiments, an absence of configured parameters for the interfering PDSCH is used to indicate that interference mitigation may not be needed/required/possible. This may be relevant e.g. if the network tries to avoid a scheduling restriction at a given time instance, and/or if the source of interference originates from other transmission points where the PQI parameter set is not known to the own eNB.

In some embodiments, a separate indication of whether interference cancellation is needed/required/possible is provided. One option for such an indication is utilizing indication of rank-1 transmission with two enabled codewords, implicitly meaning that the other codeword is interference. A transmission rank larger than 1 means that multiple spatial layers are transmitted from collocated antenna ports to the UE, whereas a rank-1 transmission with two enabled codewords means transmitting the desired and interfering layers possibly from non-collocated antenna ports and/or transmission points. Another option for the indication is a separate information element.

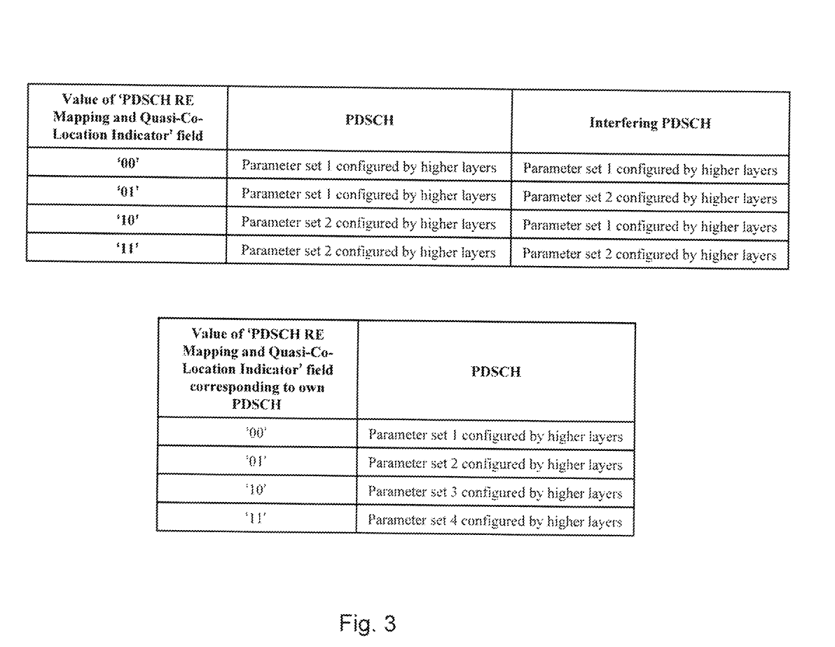

Based on this indication, UE selects between two tables. If interference cancellation is needed/required/possible, the UE utilizes the table containing the PQI for own PDSCH and interfering PDSCH. Otherwise, it uses the table containing PQI for the own PDSCH only. These tables are shown as examples in FIG. 3, where the first table corresponds to the signaling when interference cancellation is needed/required/possible (containing both PQIs), and the second table corresponds to the signaling when there is no signaling assistance for interference cancellation (only the PQI for own PDSCH is included). As mentioned above, having such fallback signaling solutions without interference cancellation based on PQI is useful if the network wants to avoid a scheduling restriction at a given time instance, and/or if the source of interference originates from other transmission points where the PQI parameter set is not known to the own eNB, for example.

As may be seen from the tables of FIG. 3, with the two bits of the PQI field, in case of interference cancellation, two parameter sets are given for both own PDSCH and interfering PDSCH (same as FIG. 2), whereas 4 configurations for the own PDSCH may be given if no interference cancellation is indicated.

According to some embodiments, two or more PQI fields in the DCI format are utilized, each one indicating the PQI information to one of the involved PDSCH transmissions, either own or interfering. This is shown in the example two tables of FIG. 4. Each of these tables substantially corresponds to the second table of FIG. 3 for the respective PDSCH. In these embodiments, additionally an indication may be given if interference cancellation is not needed/required/possible.

To summarize, in some embodiments of the invention, the UE:
may receive an indication that interference may/should be mitigated/cancelled. For example, this information is given in DCI information.
   This may be an implicit indication in the DCI, e.g. receiving an indication of transmission rank 1 while having two codewords enabled (which would mean implicitly that there is a second interfering codeword in addition to the desired one over the scheduled resources).
   This could be also explicitly signaled to the UE, e.g. the UE could be configured via RRC to mitigate/cancel interference according to received PQI information.
receives PQI information for at least one interfering PDSCH transmission. For example, it receives multiple PDSCH transmissions, at least one of which is for the UE's own (desired) PDSCH, and the rest is for interfering PDSCH transmission(s).
   As one option, the PQI can also indicate that there is no interference to be mitigated/cancelled in the subframe where the corresponding DCI and DL grant is transmitted.

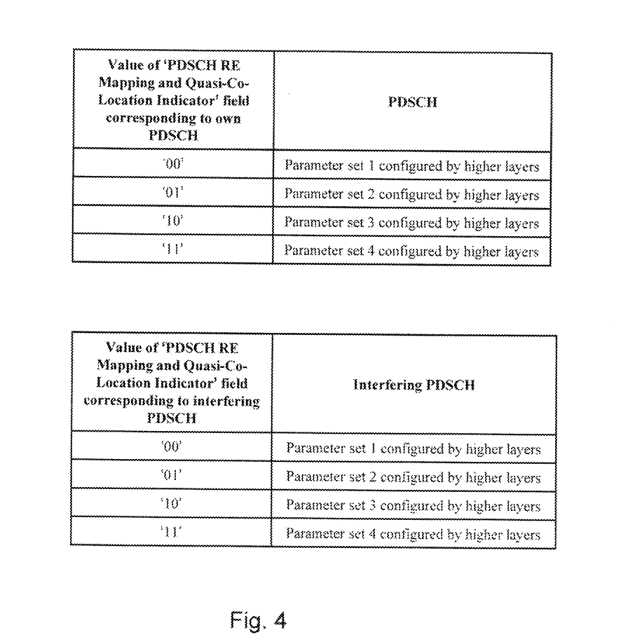

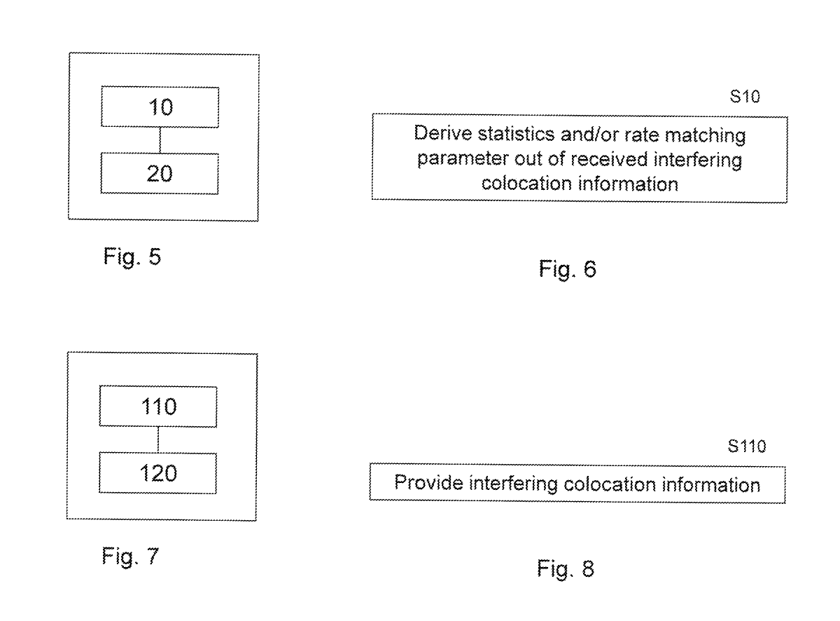

FIG. 5 shows an apparatus according to an embodiment of the invention. The apparatus may comprise a user device such as a UE, a receiver, or a part thereof. FIG. 6 shows a method according to an embodiment of the invention. The apparatus according to FIG. 5 may perform the method of FIG. 6 but is not limited to this method. The method of FIG. 6 may be performed by the apparatus of FIG. 5 but is not limited to being performed by this apparatus.

The apparatus comprises a processing system and/or at least one processor 10 and at least one memory 20. The at least one memory 20 includes computer program code, and the at least one processor 10, with the at least one memory 20 and the computer program code is arranged to cause the apparatus to at least perform deriving at least one of a statistics of an interfering channel and a rate matching parameter of the interfering channel based on an interfering colocation information (S10). The interfering colocation information is received from a serving transmission point device, serving the apparatus. The interfering channel is a channel between the apparatus and an interfering transmission point device different from the serving transmission point device.

In some embodiments, there may be multiple interfering signals involved and associated with specific transmission point devices. Each interfering signal is linked to a specific interfering channel and associated with specific (and potentially different) interfering colocation information received from a serving transmission point device. In this case, and for each said specific interfering channel, the UE derives at least one of a statistics of said specific interfering channel and a rate matching parameter of said specific interfering channel based on a specific interfering colocation information received from a serving transmission point device, wherein said specific interfering channel is a channel between the apparatus and a specific interfering transmission point device different from the serving transmission point device.

FIG. 7 shows an apparatus according to an embodiment of the invention. The apparatus may comprise a base station, a cell, or a part thereof. FIG. 8 shows a method according to an embodiment of the invention. The apparatus according to FIG. 7 may perform the method of FIG. 8 but is not limited to this method. The method of FIG. 8 may be performed by the apparatus of FIG. 7 but is not limited to being performed by this apparatus.

The apparatus comprises a processing system and/or at least one processor 110 and at least one memory 120. The at least one memory 120 includes computer program code, and the at least one processor 110, with the at least one memory 120 and the computer program code is arranged to cause the apparatus to at least perform providing an interference colocation information to a user device (S110). The interference colocation information is intended to be used for deriving at least one of a statistics of an interfering channel and a rate matching parameter of the interfering channel. The interfering channel is a channel between the user device and an interfering transmission point device different from the apparatus.

In some embodiments, the transmission point device provides multiple interference colocation information elements to a user device, wherein each interference colocation information element is intended to be used for deriving at least one of a statistics of a specific interfering channel and a rate matching parameter of a specific interfering channel, wherein said specific interfering channel is a channel between the user device and a specific interfering transmission point device different from the apparatus.

Embodiments of the invention are described based on a LTE-A system but embodiments of the invention may be applied to other radio access technologies such as LTE, WiFi, WLAN, UMTS, HSPA, GSM, e.g. if advanced receivers which are suitable for detecting an interfering signal and to cancel it out before detecting the own signal, may be employed. In principle, some embodiments of the invention may be applied to wireline networks, too.

A terminal, also named user device, may be a machine type device, a user equipment, a mobile phone, a laptop, a smartphone, a tablet PC, or any other device that may attach to a radio network. A base station, also sometimes called a cell device, may be a NodeB, an eNodeB or any other base station of the corresponding radio network. A transmission point, also sometimes called a transmission point device, may be the same as a base station or cell device or a part thereof such as an antenna port. However, according to some embodiments, a base station or cell device may comprise more than one transmission point. E.g., to one base station or cell device, several remote radio heads may be connected through backhaul.

If not otherwise stated or otherwise made clear from the context, the statement that two entities are different means that they are differently addressed in their respective network. It does not necessarily mean that they are based on different hardware. That is, each of the entities described in the present description may be based on a different hardware, or some or all of the entities may be based on the same hardware.

According to the above description, it should thus be apparent that example embodiments of the present invention provide, for example a receiver such as an iterative receiver, or a component thereof, an apparatus such as a terminal or a base station embodying the same, a method for controlling and/or operating the same, and computer program(s) controlling and/or operating the same as well as mediums carrying such computer program(s) and forming computer program product(s).

According to example embodiments of the present invention, a system may comprise any conceivable combination of the thus depicted devices/apparatuses and other network elements, which are configured to cooperate with any one of them.

In general, it is to be noted that respective functional blocks or elements according to above-described aspects can be implemented by any known means, either in hardware and/or software/firmware, respectively, if it is only adapted to perform the described functions of the respective parts. The mentioned method steps can be realized in individual functional blocks or by individual devices, or one or more of the method steps can be realized in a single functional block or by a single device.

Generally, any structural means such as a processor or other circuitry may refer to one or more of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. Also, it may also cover an implementation of merely a processor (or multiple processors) or portion of a processor and its (or their) accompanying software and/or firmware, any integrated circuit, or the like.

Generally, any procedural step or functionality is suitable to be implemented as software/firmware or by hardware without changing the ideas of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus for use in interference mitigation, the apparatus comprising a processing system, the processing system comprising at least one processor and at least one memory storing computer program code, in which the processing system is configured to cause the apparatus to at least derive at least one of one or more statistics of an interfering channel and a rate matching parameter of the interfering channel based on an interfering colocation information received from a serving transmission point device,
wherein the interfering channel comprises a channel between the apparatus and an interfering transmission point device different from the serving transmission point device.

2. The apparatus according to claim 1, the processing system being configured to cause the apparatus to derive at least one of one or more statistics of an own channel and a rate matching parameter of the own channel based on an own colocation information received from the serving transmission point device,
wherein the own channel comprises a channel between the apparatus and the serving transmission point device.

3. The apparatus according to claim 2, the processing system being configured to cause the apparatus to receive the interfering colocation information together with the own colocation information.

4. The apparatus according to claim 1, wherein the interfering colocation information comprises an indication to a reference signal considered to be transmitted by the interfering transmission point device.

5. The apparatus according to claim 1, wherein the interfering colocation information comprises at least one of the following parameters of the interfering channel:
number of cell-specific reference signal ports, cell specific reference signal frequency shift, multicast-broadcast single frequency network subframe configuration, physical downlink shared channel starting symbol, zero-power channel state information reference signal configuration.

6. The apparatus according to claim 1, the processing system being configured to cause the apparatus to:
check if an interference cancellation prohibit indication is received; and
prohibit the deriving of the at least one of the one or more statistics of the interfering channel and the rate matching parameter of the interfering channel if the interference cancellation prohibit indication is received.

7. (canceled)

8. The apparatus according to claim 1, configured to communicate according to a long term evolution standard.

9. An apparatus for use in interference mitigation, the apparatus comprising a processing system, the processing system comprising at least one processor and at least one memory storing computer program code, in which the processing system is configured to cause the apparatus to at least provide an interference colocation information to a user device,
wherein the interference colocation information is intended to be used for deriving at least one of one or more statistics of an interfering channel and a rate matching parameter of the interfering channel, and
wherein the interfering channel comprises a channel between the user device and an interfering transmission point device different from the apparatus.

10. The apparatus according to claim 9, the processing system being configured to cause the apparatus to provide an own colocation information to the user device,
wherein the own colocation information is intended to be used for deriving at least one of one or more statistics of an own channel and a rate matching parameter of the own channel, and
wherein the own channel comprises a channel between the user device and the apparatus.

11. The apparatus according to claim 10, the processing system being configured to cause the apparatus to provide the interfering colocation information together with the own colocation information.

12. The apparatus according to claim 9, wherein the interfering colocation information comprises an indication to a reference signal considered to be transmitted by the interfering transmission point device.

13. The apparatus according to claim 9, wherein the interfering colocation information comprises at least one of the following parameters of the interfering channel:
number of cell-specific reference signal ports, cell specific reference signal frequency shift, multicast-broadcast single frequency network subframe configuration, physical downlink shared channel starting symbol, zero-power channel state information reference signal configuration.

14. The apparatus according to claim 9, the processing system being configured to cause the apparatus to provide an interference cancellation prohibit indication for prohibiting the deriving of the at least one of the one or more statistics of the interfering channel and the rate matching parameter of the interfering channel.

15. (canceled)

16. The apparatus according to claim 9, configured to communicate according to a long term evolution standard.

17. A method for use in interference mitigation, the method comprising deriving at least one of one or more statistics of an interfering channel and a rate matching parameter of the interfering channel based on an interfering colocation information received from a serving transmission point device,
wherein the interfering channel comprises a channel between an apparatus performing the method and an interfering transmission point device different from the serving transmission point device.

18. The method according to claim 17, comprising deriving at least one of one or more statistics of an own channel and a rate matching parameter of the own channel based on an own colocation information received from the serving transmission point device,
wherein the own channel comprises a channel between the apparatus and the serving transmission point device.

19. The method according to claim 18, wherein the interfering colocation information is received together with the own colocation information.

20. The method according to claim 17, wherein the interfering colocation information comprises an indication to a reference signal considered to be transmitted by the interfering transmission point device.

21. The method according to claim 17, wherein the interfering colocation information comprises at least one of the following parameters of the interfering channel:
number of cell-specific reference signal ports, cell specific reference signal frequency shift, multicast-broadcast single frequency network subframe configuration, physical downlink shared channel starting symbol, zero-power channel state information reference signal configuration.

22. The method according to claim 17, comprising:
checking if an interference cancellation prohibit indication is received; and
prohibiting the deriving of the at least one of the one or more statistics of the interfering channel and the rate matching parameter of the interfering channel if the interference cancellation prohibit indication is received.

23-30. (canceled)
